(19) United States
(12) Patent Application Publication
(10) Pub. No.: US 2025/0302202 A1
(43) Pub. Date: Oct. 2, 2025

(54) ARMREST HEATER

(71) Applicant: Panasonic Automotive Systems Co., Ltd., Kanagawa (JP)

(72) Inventors: Toshihisa KISHIDA, Shiga (JP); Youichi KUROSAWA, Gifu (JP)

(21) Appl. No.: 19/081,717

(22) Filed: Mar. 17, 2025

(30) Foreign Application Priority Data
Mar. 29, 2024 (JP) 2024-055258

(51) Int. Cl. A47C 7/74; A47C 7/54; H05B 3/34

(52) U.S. Cl. CPC A47C 7/748; A47C 7/54; H05B 3/34

(57) ABSTRACT

An armrest heater according to one aspect of the present disclosure is provided on an armrest of a seat having a seat back. The armrest heater includes a sheet-like base material and a heater wire. The base material is arranged in the armrest. The heater wire is wired along a main surface of the base material. The armrest heater includes a first region on one end side in a first direction of the armrest and a second region on another end side in the first direction of the armrest. The heater wire includes a heater forming wire portion, the heater forming wire portion having a heater pattern in which a width of the first region in a second direction intersecting with the first direction is larger than a width of the second region in the second direction.

### CROSS-REFERENCE TO RELATED APPLICATIONS

This application is based upon and claims the benefit of priority from Japanese Patent Application No. 2024-055258, filed on Mar. 29, 2024, the entire contents of which are incorporated herein by reference.

### FIELD

Embodiments described herein relate generally to an armrest heater.

### BACKGROUND

In the related art, an armrest heater mounted on an armrest is disclosed as in Japanese Patent Application Laid-open No. 2019-38321. In the armrest heater in the related art as disclosed in Japanese Patent Application Laid-open No. 2019-38321, electric heating wire is arranged in a meandering manner in a front-back direction of a seat to be arranged over the entire region of nonwoven fabric.

However, in the armrest heater in the related art, heater wire is arranged also in a wrist region so that an elbow region and an armrest width in its short direction are the same, and thus there is room for improvement from the viewpoint of energy saving.

An object of non-limiting examples of the present disclosure is to solve the above problem and to enable energy saving of an armrest.

### SUMMARY

An armrest heater according to an embodiment of the present disclosure is provided on an armrest of a seat having a seat back. The armrest heater includes: a sheet-like base material that is arranged in the armrest; and a heater wire that is wired along a main surface of the base material. The armrest heater includes a first region on one end side in a first direction of the armrest and a second region on another end side in the first direction of the armrest. The heater wire includes a heater forming wire portion, the heater forming wire portion having a heater pattern in which a width of the first region in a second direction intersecting with the first direction is larger than a width of the second region in the second direction.

### BRIEF DESCRIPTION OF THE DRAWINGS

FIG. 1 is a side view illustrating an exemplary seat of a moving body having an armrest heater according to an embodiment;

FIG. 2 is a perspective view illustrating the exemplary seat of the moving body having the armrest heater according to the embodiment;

FIG. 3 is a schematic cross-sectional view illustrating a cross section of an armrest taken along line D-D in FIG. 2;

FIG. 4 is a block diagram illustrating an outline of a heater device including the armrest heater according to the embodiment;

FIG. 5 is a schematic view illustrating an armrest heater according to a comparative example;

FIG. 6 is a schematic view illustrating the armrest heater according to the embodiment;

FIG. 7 is a schematic view illustrating an armrest heater of which a main wire portion extends in an X-axis direction according to the embodiment;

FIG. 8 is a schematic cross-sectional view illustrating an armrest when an occupant places an arm on the armrest;

FIG. 9 is a schematic view illustrating an armrest heater according to a first modification of the embodiment;

FIG. 10 is a schematic view illustrating an armrest heater in which a folded portion of a heater wire is wired on a straight line in a human body region according to the first modification of the embodiment;

FIG. 11 is a schematic view illustrating an armrest heater 1 having a fourth region according to a second modification of the embodiment;

FIG. 12 is a schematic view illustrating an armrest heater having different wiring intervals in a main wire portion according to a third modification of the embodiment;

FIG. 13 is a schematic cross-sectional view illustrating an armrest in which an armrest heater is arranged on a back surface of a cushion layer;

FIG. 14 is a schematic cross-sectional view illustrating an armrest in which an armrest heater is arranged on a back surface of a cushion layer when an occupant places an arm on the armrest; and

FIG. 15 is a schematic view illustrating an armrest heater obtained by combining the second modification with the first modification of the embodiment.

### DETAILED DESCRIPTION

Hereinafter, preferred embodiments of the present disclosure are described in detail with reference to the accompanying drawings. Note that, in the present specification and drawings, components having substantially the same function are denoted by the same reference numerals, and redundant description is omitted. However, in the description of each drawing, only main components are denoted by reference numerals, and even components having the same or substantially the same functions as those described above in the previous drawings may not be denoted by reference numerals. Note that the following embodiments are merely examples for describing the present disclosure and are not intended to limit the present disclosure. For example, a shape, a structure, a material, a component, a relative positional relationship, a connection state, a numerical value, a mathematical expression, contents of each step in a method, an order of steps, and the like described in the following embodiments are merely examples and may include contents that are not described below. In addition, geometric expressions such as parallel and orthogonal may be used, but these expressions do not indicate mathematical strictness and include substantially acceptable errors, deviations, and the like. Also, expressions such as simultaneous and identical include substantially acceptable ranges.

### Embodiment

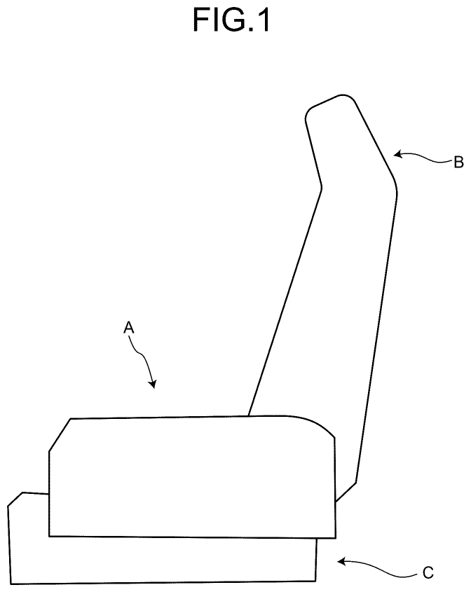

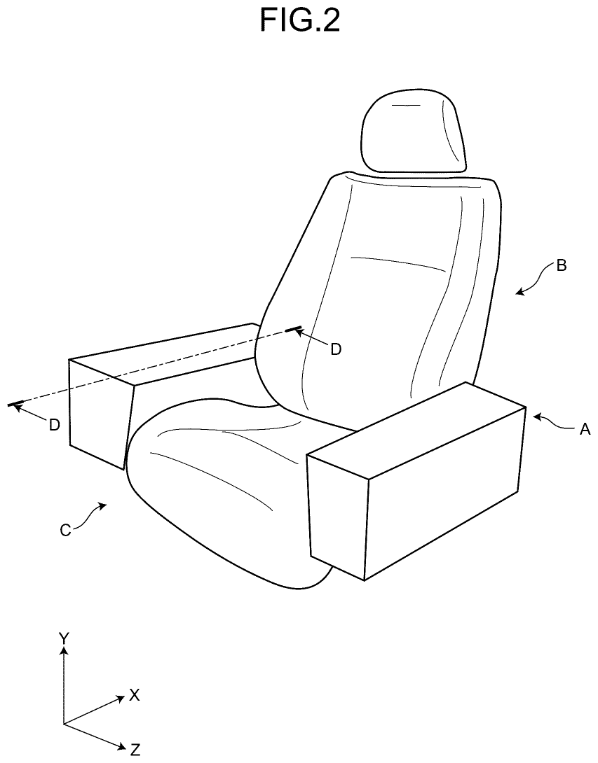

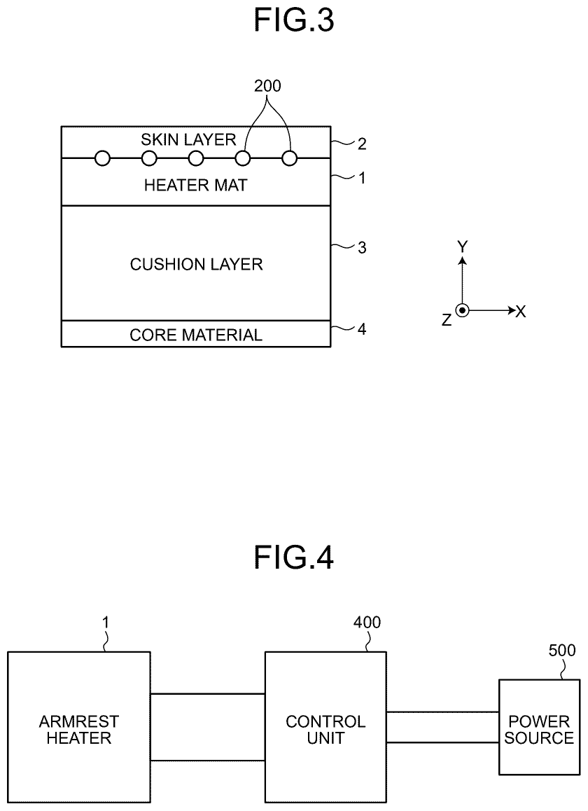

An armrest heater 1 of the present disclosure is applied to, for example, an armrest A provided in a seat of a moving body such as an automobile. FIG. 1 is a side view illustrating an exemplary seat of a moving body having the armrest heater 1 according to the embodiment. Also, FIG. 2 is a perspective view illustrating the exemplary seat of the moving body having the armrest heater 1 according to the embodiment. The seat of the moving body includes the armrest A on which an arm of an occupant in a state of being seated is placed and that supports the arm of the occupant, a seat back B that supports an upper body of the occupant and is used as a backrest, and a seat cushion C on which the occupant is seated. FIG. 3 is a schematic cross-sectional view schematically illustrating a cross section of the armrest A. FIG. 3 is a schematic cross-sectional view illustrating the armrest A taken along line D-D in FIG. 2. A Y axis illustrated in FIG. 3 is defined as a height direction of the moving body, and a positive side of the Y axis is defined as a surface side of members to be stacked, and a negative side of the Y axis is defined as a back side. In addition, a Z axis is defined as a width direction of the moving body, a direction from the armrest on the left side in FIG. 2 toward the center of the seat back B is defined as a positive side of the Z axis, and the opposite side is defined as a negative side of the Z axis. Also, an X axis in FIG. 2 is a traveling direction of the moving body, the seat back B side is a positive side of the X axis, and an opposite side is a negative side of the X axis. That is, the short direction of the armrest A in a state of being used by the seated occupant is the Z-axis direction, and the longitudinal direction of the armrest A is the X-axis direction. Note that, in the claims, a first direction corresponds to the X-axis direction or the longitudinal direction of the armrest A, and a second direction corresponds to the Z-axis direction or the short direction of the armrest A. In all the following drawings, the X, Y, and Z axes are similarly applied. The armrest A illustrated in FIG. 3 includes a skin layer 2, the armrest heater (heater mat) 1, a cushion layer 3, and a core material 4.

The skin layer 2 is the outermost layer of the armrest A and is provided so as to cover the armrest heater 1, the cushion layer 3, and the core material 4. The front surface (main surface) of the skin layer 2 is a surface to which a load is applied by an arm of an occupant in a state of being seated on a seat of a moving body. Also, the skin layer 2 can also impart designability to the armrest A. Examples of the material of the skin layer 2 include synthetic leather formed of a synthetic resin material such as polyurethane or polyvinyl chloride, a fabric, and a natural leather material such as cow skin or sheep skin.

The cushion layer 3 is provided on the surface side of the core material 4. Examples of the material of the cushion layer 3 include a foam such as urethane.

The core material 4 is formed using a hard resin material so as to have a substantially uniform thickness as a whole.

In the embodiment, the armrest heater 1 is arranged on the surface side of the cushion layer 3 and on the back side of the skin layer 2. Specifically, the armrest heater 1 according to the embodiment is arranged immediately below the skin layer 2. Details of the stacking position of the armrest heater 1 are described below.

The armrest heater 1 includes a sheet-like base material 100 and a heater wire 200 that is woven into the base material 100 and connected to a control unit 400 that controls heat generation of the heater. FIG. 4 is a block diagram illustrating an outline of a heater device including the armrest heater 1 according to the embodiment. The control unit 400 controls supply and stop of electric power from a power source 500 to the armrest heater 1.

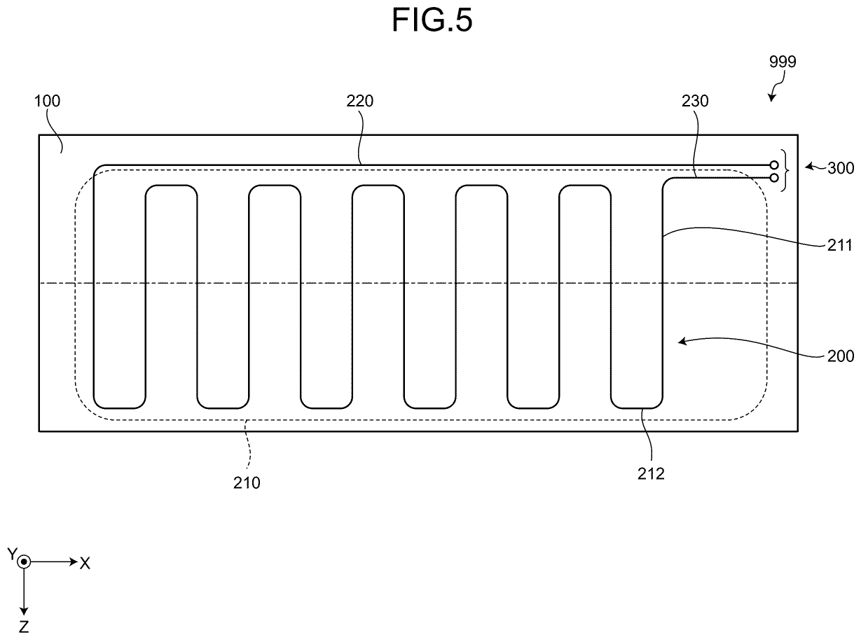

FIG. 5 is a schematic view illustrating an armrest heater 999 according to a comparative example. It is assumed that the armrest is in a use state in which the armrest is substantially parallel to the seat cushion C when a mounting target of the armrest heater 999 in FIG. 5 is a seat for a moving body.

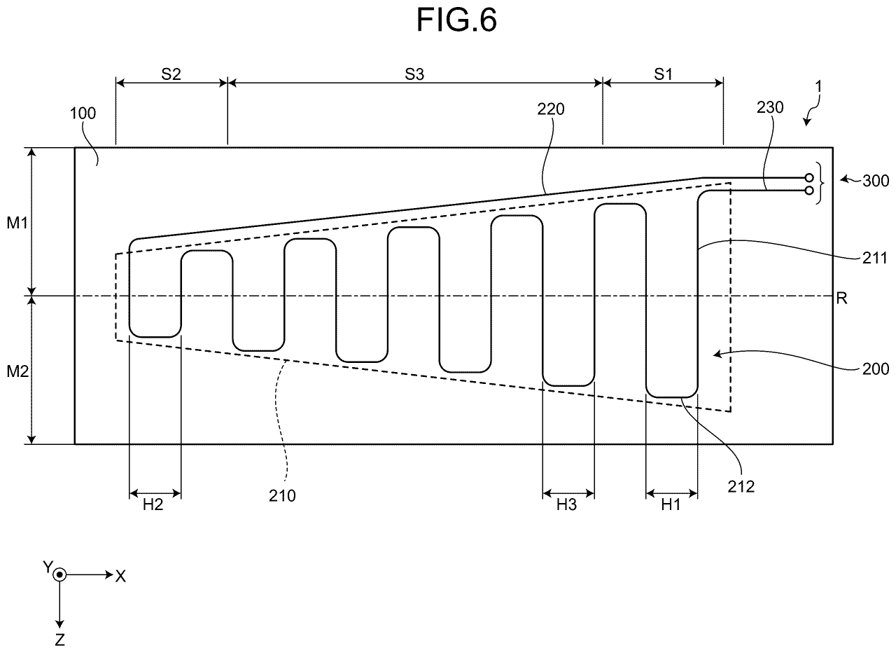

A detailed configuration of the armrest heater 1 according to the embodiment of the present disclosure is described. FIG. 6 is a schematic view illustrating the armrest heater 1 according to the embodiment of the present disclosure. Note that when the example of the present disclosure is a seat for a moving body, in the armrest heater 1, it is assumed that the armrest A is in a use state in which the seat cushion C and the skin layer 2 are substantially parallel as illustrated in FIGS. 1 and 2.

The base material 100 includes a heater terminal 300, and the heater wire 200 electrically connected to the control unit 400 through the heater terminal 300 is arranged on the base material 100.

The heater wire 200 includes a heater forming wire portion 210 woven into the base material 100 so as to form a heater pattern in a shape desired to be heated in a portion desired to be heated on the armrest A. In addition, the heater wire 200 includes a heater connection wire portion 220 that is electrically connected to the control unit 400 that performs heat generation control of the heater wire 200 on the armrest A. Also, the heater forming wire portion 210 includes a heater connection end portion 230 that connects the heater terminal 300 closest to the positive side of the Z axis among the two heater terminals 300 and the heater forming wire portion 210. One end of the heater connection wire portion 220 is electrically connected to the control unit 400, and the other end is electrically connected to the control unit 400 via the heater forming wire portion 210. More specifically, the one end of the heater connection wire portion 220 is electrically connected to the control unit 400, and the other end is electrically connected to the control unit 400 via the heater pattern formed on the heater forming wire portion 210 and the heater connection end portion 230.

The heater forming wire portion 210 includes a main wire portion 211 extending in the Z-axis direction of the armrest and a folded portion 212 extending in the X-axis direction of the armrest. As illustrated in FIG. 6, the heater wire 200 that is connected to the heater terminal 300 on the positive side of the Z axis among heater terminals 300 forms the main wire portion 211 toward the positive side of the Z axis. When reaching an end of base material 100, the heater wire 200 extends in the negative direction of the X axis to form the folded portion 212. Thereafter, the main wire portion 211 is formed to extend toward the negative side of the Z axis. By repeating this, the heater wire 200 forms a heater pattern by the heater forming wire portion 210 and is then connected to the heater terminal 300 on the negative side of the Z axis out of the heater terminal 300 by the heater connection wire portion 220.

As a material of the heater wire 200, a wire material made of a metal material that generates heat by energization, such as a copper alloy, nichrome, or nickel is considered. The heater wire 200 is connected to the control unit 400 and generates heat when electricity flows from the control unit 400.

As illustrated in FIG. 6, the armrest heater 1 according to the embodiment of the present disclosure includes a first region S1 on one end side of the armrest heater 1 and a second region S2 on the other end side of the armrest heater 1. In other words, the armrest heater 1 includes the first region S1 and the second region S2 provided on the opposite side of the seat back B from the first region S1. Also, the armrest heater 1 may have a third region S3 arranged between the first region S1 and the second region S2. In addition, when the occupant places the arm on the armrest A such that the elbow to the wrist are in contact with the armrest A, a region where the elbow is considered to be in contact with the armrest A may be referred to as the first region S1, a region where the arm is considered to be in contact with the armrest A may be referred to as the third region S3, and a region where the wrist is considered to be in contact with the armrest A may be referred to as the second region S2. Also, regardless of the contact with the arms of the occupant, for example, the area of the armrest A may be divided to be 1:3:1 or the like or to be the first region S1:the third region S3:the second region S2=1:3:1 with respect to the length of each region in the X-axis direction, and the divided regions may be defined as the first region S1, the third region S3, and the second region S2 from the side closer to the seat back B. Also, with respect to the length of each region in the X-axis direction, the first region S1:the third region S3:the second region S2=1:1:1 or the like may be satisfied. Note that the armrest heater 1 may be divided into at least two portions and may be divided into four or more portions. At this time, the first region S1, the second region S2, and the third region S3 do not need to be adjacent to each other. With respect to the first region S1 and the second region S2, the first region S1 may be on the seat back B side, and appropriate determination can be made.

As illustrated in FIG. 6, the armrest heater 1 according to the embodiment of the present disclosure includes the sheet-like base material 100 that is arranged in the armrest A that supports an arm of the occupant and the heater wire 200 that is wired to a heating portion of the base material 100. Also, the armrest heater 1 includes the first region S1 that is closest to the seat back B of the armrest A and the second region S2 that is provided on the opposite side of the seat back B from the first region S1. The heater wire 200 includes the heater forming wire portion 210 in which a heater pattern in which a width in the first region S1 in a second direction (Z-axis direction, short direction) intersecting the first direction (X-axis direction, longitudinal direction) is larger than a width in the second region S2 in the second direction is formed. That is, the heater wire 200 is arranged so that the width of the heater forming wire portion 210 in the first region S1 in the short direction of the armrest A is larger than the width of the heater forming wire portion 210 in the second region S2 in the short direction of the armrest A. The width of the heater forming wire portion 210 in the second direction (the width of the armrest A in the short direction) referred to herein may be an interval between the folded portion 212 and the subsequently formed folded portion 212 in the Z-axis direction or may be a length of the main wire portion 211.

The heater wire 200 may be arranged so that the length of the main wire portion 211 of the heater wire 200 in the first region S1 is longer than the length of the main wire portion 211 of the heater wire 200 in the second region S2. Here, the length of the main wire portion 211 in the first region S1 refers to the length of the longest main wire portion 211 among at least one main wire portion 211 existing in the first region S1. The same is applied to the main wire portion 211 in the second region S2 and the main wire portion 211 in the third region S3. For example, when the length of the main wire portion 211 in the first region S1 in the Z-axis direction is 10 cm, if the length of the main wire portion 211 in the second region S2 is 5 cm, it can be said that the length of the main wire portion 211 in the first region S1 is longer than the length of the main wire portion 211 in the second region S2. When the length of the main wire portion 211 in the first region S1 changes from 10 cm to 9 cm in the negative direction of the X axis, and the length of the main wire portion 211 in the second region S2 changes from 6 cm to 5 cm in the negative direction of the X axis, it can be said that the length of the main wire portion 211 in the first region S1 is longer than the length of the main wire portion 211 in the second region S2 by comparing 10 cm of the main wire portion 211 in the first region S1 and 6 cm in the second region S2.

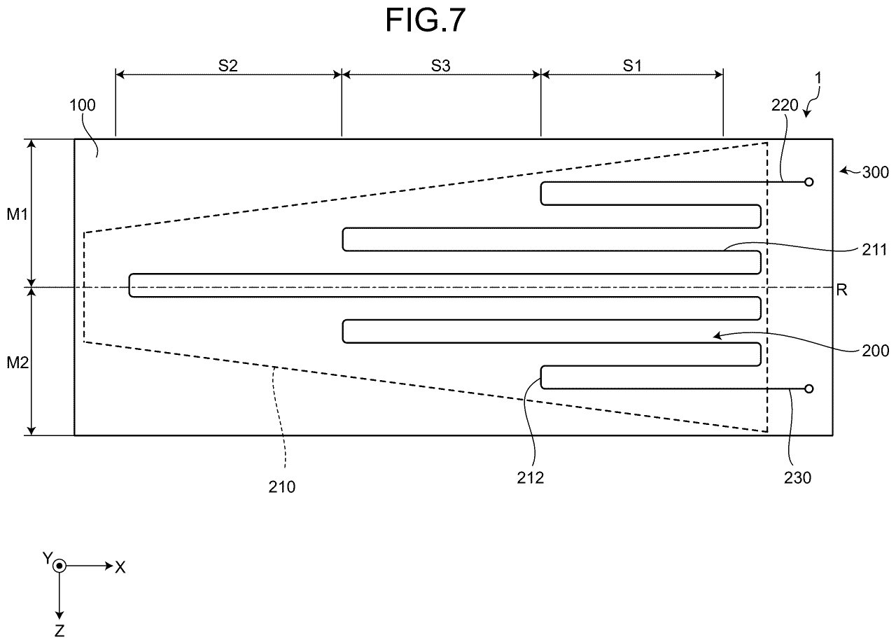

Also, the main wire portion 211 may extend along the X-axis direction, and the folded portion 212 may extend along the Z-axis direction. FIG. 7 is a schematic view illustrating the armrest heater 1 according to the embodiment of the present disclosure, in which the main wire portion 211 extends along the X-axis direction, and the folded portion 212 extends along the Z-axis direction. The width of the heater forming wire portion 210 in the short direction of the armrest A referred to herein refers to an interval between the main wire portion 211 closest to the positive side of the Z axis and the main wire portion 211 closest to the negative side of the Z axis among the main wire portions 211 arranged in the respective regions.

As illustrated in FIGS. 6 and 7, the width of the heater forming wire portion 210 in the third region S3 in the second direction (short direction) is preferably less than the width of the heater forming wire portion 210 in the first region S1 in the second direction (short direction) and longer than the width of the heater forming wire portion 210 in the second region S2 in the second direction (short direction). Also, in FIG. 6, the length of the main wire portion 211 in third region S3 is preferably less than the length of the main wire portion 211 in the first region S1 and longer than the length of the main wire portion 211 in the second region S2. In other words, it is preferable that the length of the main wire portion 211 of the meandering heater forming wire portion 210 arranged from the first region S1 to the third region S3 and from the third region S3 to the second region S2 is gradually shortened.

In FIGS. 6 and 7, the heater wire 200 is preferably arranged so that the heater pattern in the heater forming wire portion 210 has a tapered trapezoidal shape. More specifically, the heater wire 200 is preferably arranged to have a trapezoidal shape having a long base in the first region S1 and a short base in the second region S2.

In the armrest heater 1 according to the embodiment of the present disclosure illustrated in FIG. 6, the heater wire 200 connected to the heater terminal 300 extends in the first region S1 toward the positive side of the Z axis to form the main wire portion 211. When reaching an end of the base material 100 (or an end of the armrest A), the heater wire 200 extends toward the negative side of the X axis to form the folded portion 212. After forming the folded portion 212 having a predetermined length, the heater wire 200 extends toward the negative side of the Z axis to form the main wire portion 211. At this time, the main wire portion 211 is arranged so as to have a length shorter than that of the main wire portion 211 before being folded back. Thereafter, similarly, every time the folded portion 212 is formed, by shortening the main wire portion 211, a trapezoidal heater pattern tapered from the first region S1 toward the second region S2 as illustrated in FIG. 6 is formed.

Here, related to the armrest heater 1 according to the present disclosure, one of the differences from the armrest heater 999 of the comparative example is described. As illustrated in FIG. 5, in the armrest heater 999 according to the comparative example, the heater wire 200 is arranged so as to fill the front surface of the armrest A in a state in which widths in the Z-axis direction are identical and wiring intervals in the X-axis direction are identical. However, when the arm is actually placed on the armrest A, it is considered that the arm is tapered from the elbow to the wrist, and the contact area of the wrist with the armrest A is smaller than the contact area of the portion of the arm on the elbow side with the armrest A. Therefore, in the wiring as illustrated in FIG. 5, it is considered that unnecessary wiring is provided for the contact area of the wrist in the region near the wrist. Meanwhile, in the embodiment of the present disclosure, as illustrated in FIG. 6, the length of the main wire portion 211 is gradually shortened from the first region S1 toward the second region S2, so that the heater wire 200 is wired along the shape of the arm. Therefore, energy saving can be performed while efficiently warming the arm of the occupant.

At this time, if the width of the heater forming wire portion 210 in the first region S1 is larger than the width of the heater forming wire portion 210 in the second region S2, the heater pattern in the heater forming wire portion 210 may not be trapezoidal. For example, the heater pattern may be arched or triangular.

In the embodiment of the present disclosure, the heater wire 200 is arranged so that a wiring interval H1 of the main wire portion 211 in the first region S1 is identical to a wiring interval H2 of the main wire portion 211 in the second region S2. Note that, for example, when the wiring interval H1 is 3 cm, the wiring interval H2 may be identical to 2.5 cm, 3.5 cm, or the like and may include a slight error that may occur in production or a slight difference due to design restriction. More preferably, the wiring interval H1 of the main wire portion 211 in the first region S1, the wiring interval H2 of the main wire portion 211 in the second region S2, and a wiring interval H3 of the main wire portion 211 in the third region S3 are arranged to be identical to each other. Note that when there is only one main wire portion 211 in the first region S1, the wiring interval between the main wire portion 211 arranged in the first region S1 and the main wire portion 211 in the other region adjacent to the main wire portion 211 arranged in the first region S1 is referred to as the wiring interval H1 of the main wire portion 211 in the first region S1. Further, in the embodiment of the present disclosure illustrated in FIG. 6, the folded portion 212 is straight and arranged in parallel with the longitudinal direction of the armrest A, but at this time, the shape of the folded portion 212 may be a straight line, a curved line, or a V shape. Similarly, the shape of the main wire portion 211 may be a straight line or a curved line. By disposing the main wire portion 211 so that the wiring intervals of the main wire portion 211 in the first region S1, the second region S2, and the third region S3 are identical to each other, the amount of heat generation in the X-axis direction of the heat generation region by the heater forming wire portion 210 is constant, and heat equalization can be performed. Therefore, the occupant can obtain the same degree of thermal sense, for example, in the elbow portion and the wrist portion of the armrest A heated by the armrest heater 1.

As illustrated in FIG. 3, in the armrest A including the skin layer 2 and the cushion layer 3, the armrest heater 1 is arranged on the back side of the skin layer 2 that covers the front surface of the armrest A. Specifically, the armrest heater 1 according to the embodiment of the present disclosure is arranged on the back side of the skin layer 2 without interposing the cushion layer 3 therebetween. More preferably, the armrest heater 1 is arranged immediately below the skin layer 2. By disposing the armrest heater 1 on the back side of the skin layer 2, the armrest heater 1 can directly warm the skin layer 2, so that excellent quick warmth is exhibited.

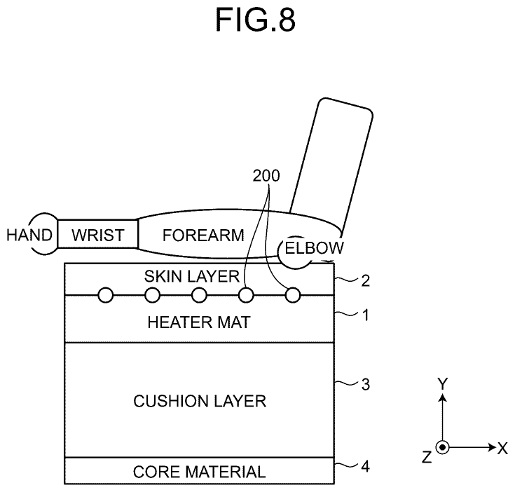

FIG. 8 is a schematic cross-sectional view illustrating the armrest A when an occupant places an arm on the armrest A. As illustrated in FIG. 8, when the armrest heater 1 is arranged immediately below the skin layer 2 without interposing the cushion layer 3 therebetween, a distance between the arm of the occupant and the armrest heater 1 does not substantially change when the occupant places the arm on the armrest A. Therefore, by disposing the heater wire 200 so that the wiring interval H1 of the main wire portion 211 in the first region S1 and the wiring interval H3 of the main wire portion 211 in the third region S3 are substantially identical to each other, the amount of heat generated in the heater forming wire portion 210 in the X-axis direction with respect to the arm contact surface is substantially constant, and thus the occupant can obtain uniform thermal sense at each portion such as the wrist, the forearm, and the elbow. Note that not only the armrest A illustrated in FIG. 3 but also the armrest A using a material having high hardness, a wooden plate, or the like for the skin layer has substantially no change in the distance between the arm of the occupant and the armrest heater 1, so that the same effect can be obtained.

As described above, the heater wire 200 includes the heater forming wire portion 210 and the heater connection wire portion 220. The heater connection wire portion 220 that connects the heater forming wire portion 210 after the heater pattern is formed and the heater terminal 300 refers to the heater wire 200 that connects the main wire portion 211 arranged to be closest to the negative side in the X axis in the heater forming wire portion 210 and the heater terminal 300. Alternatively, the heater connection wire portion 220 refers to the heater wire 200 that extends from the heater terminal 300 and connects the heater forming wire portion 210 forming at least one main wire portion 211 and the heater terminal 300. As also illustrated in FIG. 6, the heater connection wire portion 220 is arranged on the center side of the seat back B than the heater forming wire portion 210, that is, on the side opposite to the occupant side (the negative direction side of the Z axis). Alternatively, when the occupant side from a line segment R bisecting one side of the armrest A in the short direction is defined as a human body region M2, and the door side is defined as a door region M1, the heater connection wire portion 220 is preferably arranged in the door region M1. Describing with reference to FIG. 6, when a region on the negative side of the Z axis with respect to the line segment R is defined as the door region M1, and a region on the positive side of the Z axis with respect to the line segment R is defined as the human body region M2, the heater connection wire portion 220 is arranged in the door region M1. The line segment R is a line segment along the longitudinal direction that bisects the area of the armrest A. This is because, for example, when the armrest heater 1 is mounted on the armrest A of the seat of the moving body, a likeliness that the temperature of the armrest A decreases in the door region M1 due to an influence of emission of heat radiation to outside air (cold radiation), heat conduction to an outer plate surface cooled by the outside air, or the like is considered. Therefore, by disposing the heater connection wire portion 220 in the door region M1 and using heat of the heater connection wire portion 220, an influence of cold radiation or the like in door region M1 can be suppressed. In the present embodiment, the heater connection wire portion 220 is a straight line that does not form a pattern but is not intended to limit the shape.

### First Modification

A first modification is different from the embodiment in that the heater forming wire portion 210 is wired to be offset toward the center side of the seat back B, that is, on the occupant side in a state in which the armrest A is used by the occupant seated on the seat.

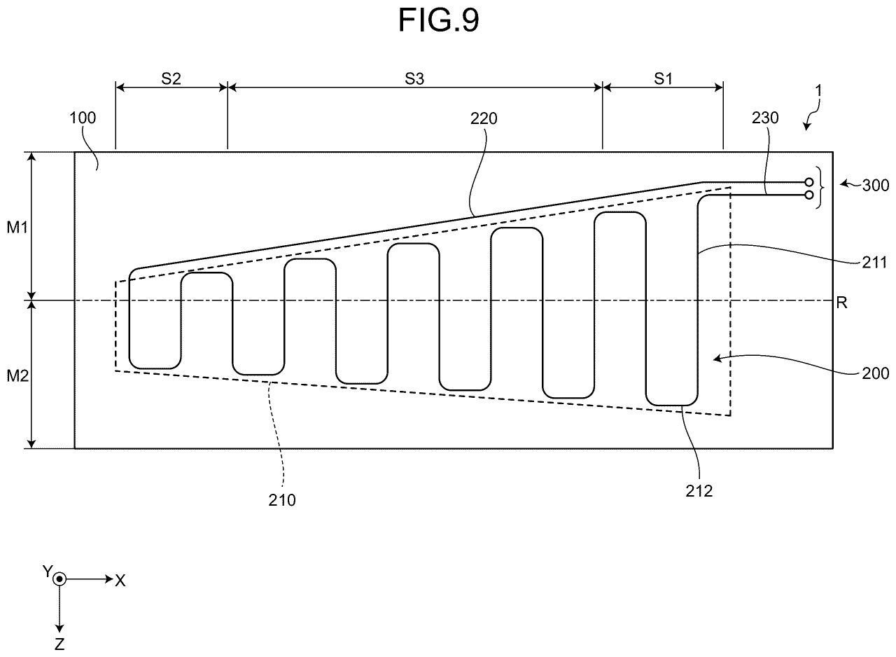

FIG. 9 is a schematic view of the armrest heater 1 in which the heater wire 200 is offset toward the center side of the seat back B according to the first modification of the embodiment of the present disclosure. The term “being offset” referred to herein refers to a state of being arranged so that the center point of the main wire portion 211 arranged in the third region S3 is positioned closer to the center side of the seat back B than the center point of the main wire portion 211 arranged in the first region S1.

Here, in the armrest heater 1, a surface of the armrest A on which the occupant places the arm is defined as a front surface, the center side of the seat back B from the line segment R along a longitudinal direction that bisects an area of the front surface is defined as the human body region M2, and an opposite side is defined as the door region M1. At this time, for example, a state in which the distance between the end of the main wire portion 211 on the human body side out of the two ends (both ends) of the main wire portion 211 in the second region S2 and the side closest to the human body side of the armrest A is shorter than the distance between the end of the main wire portion 211 on the door side and the side closest to the door side of the armrest A may be referred to as being offset toward the center side of the seat back B.

Further, being arranged so that the wiring area by the heater forming wire portion 210 in the human body region M2 is larger than the wiring area by the heater forming wire portion 210 in the door region M1 may be referred that the heater wire 200 is offset toward the center side of the seat back B. The wiring area referred to herein refers to an area of a virtual figure formed when vicinities of corners of the folded portion 212 adjacent in the longitudinal direction are virtually connected by line segments in the heater forming wire portion 210 as indicated by a broken line in FIG. 9. In other words, being offset is a state in which points bisecting the respective main wire portions 211 are arranged in the human body region M2. Alternatively, the ratio of the length arranged in the human body region M2 to the length of the main wire portion 211 increases, as it goes from the first region S1 to the second region S2.

When the occupant places an arm on the armrest A so that the back of the hand faces the ceiling of the moving body, in many cases, it is considered that the side surface of the arm on the side opposite to the human body side curves toward the center of the human body from the elbow to the wrist. At this time, as described above, in the armrest heater 1 of the present modification, since the heater wire 200 is close to the human body side, it is possible to more accurately correspond to the shape of the arm of the occupant, and thus the arm of the occupant can be warmed more efficiently.

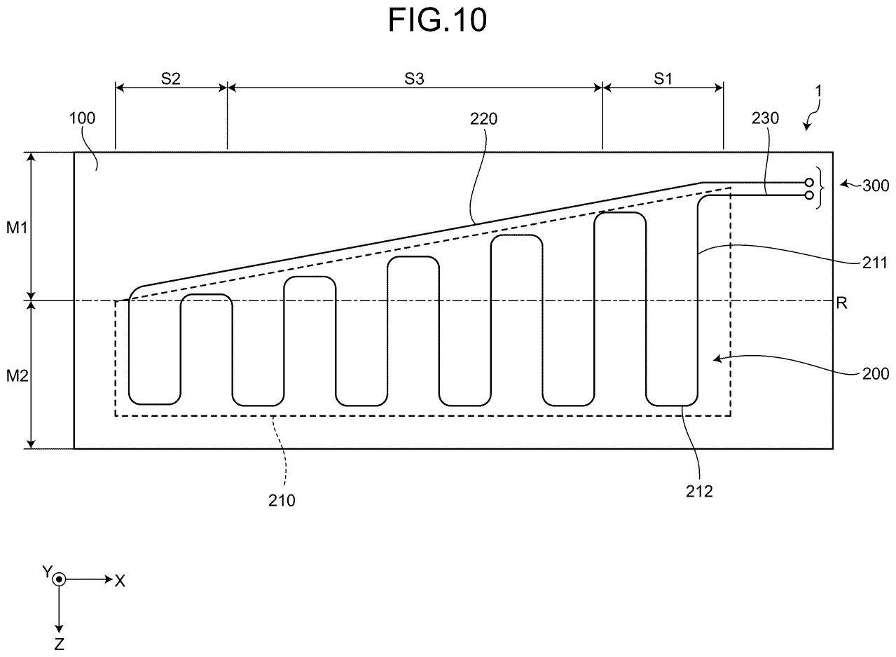

It is considered that the folded portions 212 are arranged on the same straight line. FIG. 10 is a schematic view illustrating the armrest heater 1 in which the folded portion 212 of the heater wire 200 is wired on a straight line in the human body region M2 according to the first modification of the embodiment. As illustrated in FIG. 10, in the human body region M2, the folded portion 212 arranged in the first region S1, the folded portion 212 arranged in the second region S2, and the folded portion 212 arranged in the third region S3 are arranged on the same straight line parallel to the X axis, and the heater forming wire portion 210 is formed to be closer to the human body side. As a result, the arm of the occupant can be warmed more efficiently because the arm is closer to the human body side than the configuration of FIG. 9. As illustrated in FIGS. 9 and 10, the shape of the heater pattern of the heater forming wire portion 210 is not limited as long as the number of wirings of the heater forming wire portion 210 on the human body side increases, and the length of the main wire portion 211 in the second region S2 is shorter than the length of the main wire portion 211 in the first region S1.

### Second Modification

A second modification is different from the embodiment in that the armrest heater 1 includes a fourth region S4 on the side opposite to the seat back B side from the second region S2.

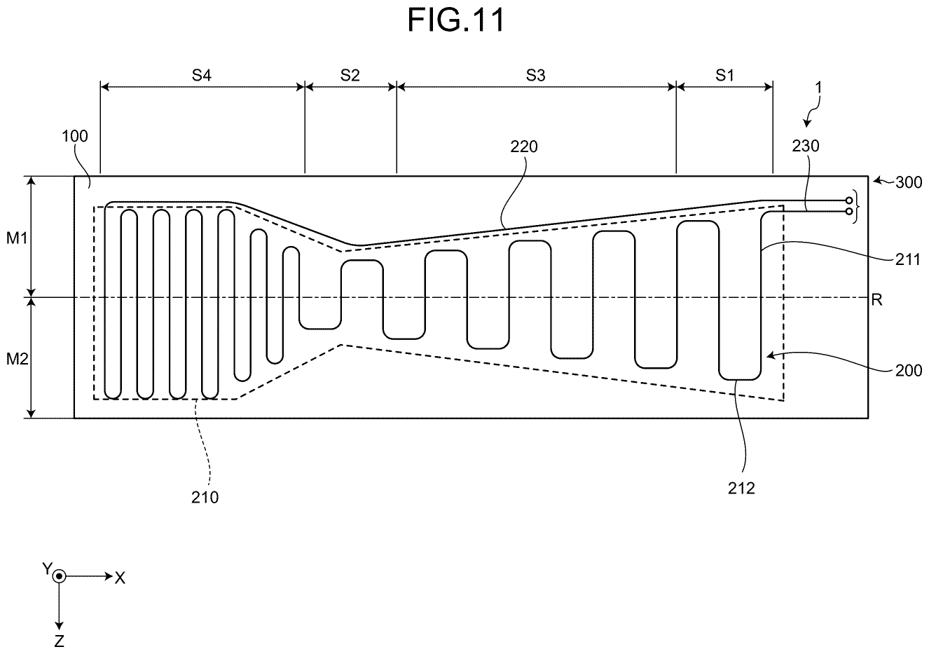

FIG. 11 is a schematic view illustrating the armrest heater 1 having the fourth region S4 according to the second modification of the embodiment of the present disclosure. As described above, the armrest heater 1 includes the fourth region S4 on the negative side of the X axis from the second region S2. In many cases, the fourth region S4 is a region that is considered to be frequently in contact with the palm when the occupant places the arm on the armrest A.

The wiring density of the fourth region S4 is higher than the wiring density of the first region S1, the wiring density of the second region S2, and the wiring density of the third region S3. The wiring density referred to herein refers to the amount of wiring per unit area with respect to the region. In other words, the interval between the plurality of folded portions 212 formed in the fourth region S4 is shorter than the intervals between the folded portions 212 formed in the first region S1, the second region S2, and the third region S3. According to this, since the wiring interval of the main wire portion 211 decreases, and the wiring density of the fourth region S4 increases, the amount of heat generated per unit area in the fourth region S4 is larger than that in the first region S1, the second region S2, and the third region S3.

The palm of the occupant frequently touches the fourth region S4, and the palm is easily cooled at the end of the human body. Therefore, in the armrest heater 1 of the present modification, by setting the wiring density of the fourth region S4 to be higher than the wiring density of the first region S1, the wiring density of the second region S2, and the wiring density of the third region S3, it is possible to make the palm that is easily cooled have the same thermal sense as other parts of the arm. Further, the heater pattern is formed into a trapezoidal shape from the first region S1 to the second region S2 as illustrated in FIG. 11 while having the fourth region S4, it is possible to save energy while efficiently warming the arm.

### Third Modification

A third modification is different from the embodiment in that the heater wire 200 is arranged so that the wiring interval H1 of the main wire portion 211 in the first region S1 is larger than the wiring interval H2 of the main wire portion 211 in the second region S2.

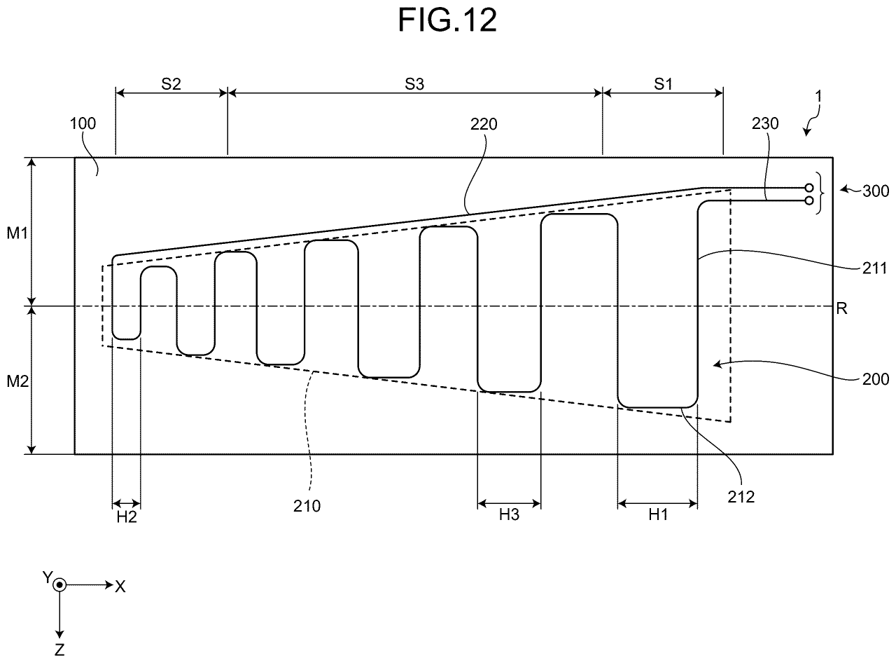

FIG. 12 is a schematic view illustrating the armrest heater 1 having different wiring intervals in the main wire portion 211 according to the third modification of the embodiment of the present disclosure. As illustrated in FIG. 12, the heater wire 200 is arranged so that the wiring interval H1 of the main wire portion 211 in the first region S1 is larger than the wiring interval H2 of the main wire portion 211 in the second region S2. In other words, the wiring density of the first region S1 is sparse, and the wiring density of the second region S2 is dense. Note that the wiring interval H1 of the main wire portion 211 in the first region S1 referred to herein is an interval of the main wire portion 211 when at least one of the two main wire portions 211 is arranged in the first region S1. Also, when two or more wiring intervals H1 of the main wire portion 211 in the first region S1 are present, the wiring interval H1 refers to the largest wiring interval. At this time, the shape of the folded portion 212 may be a straight line, a curved line, or a V shape, and the shape thereof is not limited. In the human body, since the wrist is close to the end and is more easily cooled than the elbow, the arm of the occupant can be efficiently warmed in accordance with the ease of cooling by causing the amount of heat generation of the wrist to be larger than the amount of heat generation of the elbow. Therefore, heat generation in a portion in which the wrist is not positioned can be suppressed, and the wrist that is easily cooled can be warmed, so that the efficiency of the armrest heater 1 can be further improved.

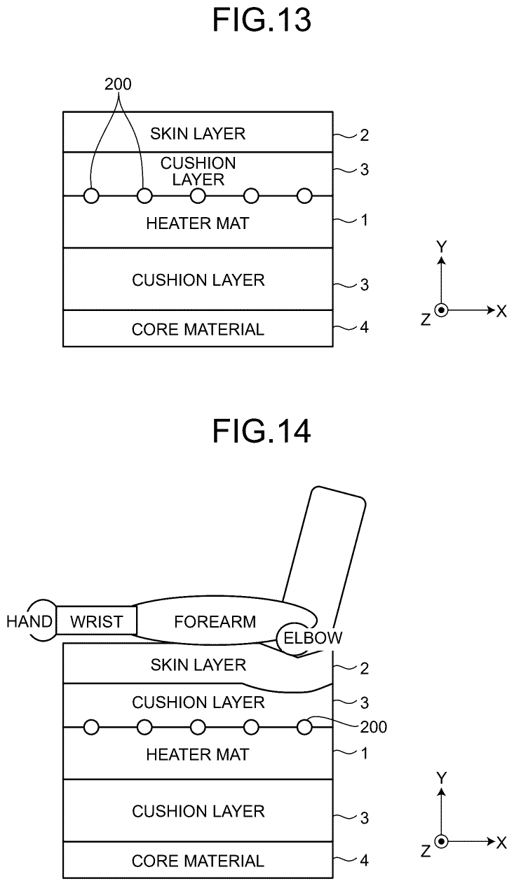

Also, at this time, the armrest heater 1 may be arranged on the back surface of the cushion layer 3 of the armrest A. FIG. 13 is a schematic cross-sectional view illustrating the armrest A in which the armrest heater 1 is arranged on a back surface of the cushion layer 3. As illustrated in FIG. 13, in the armrest A including the skin layer 2, the cushion layer 3, and the armrest heater 1, the armrest heater 1 is arranged on the back side of the cushion layer 3 newly arranged with respect to the configuration of FIG. 3. That is, the armrest heater 1 is configured to be arranged between the two cushion layers 3. By disposing the armrest heater 1 on the back surface of the cushion layer 3, the heater wire 200 is less likely to be damaged even when used for a long period of time. FIG. 14 is a schematic cross-sectional view illustrating the armrest A in which the armrest heater 1 is arranged on a back side of the cushion layer 3 when the occupant places an arm on the armrest. As illustrated in FIG. 14, when the armrest heater 1 is arranged on the back side of the cushion layer 3, and the occupant places the arm on the armrest A, the distance between each part of the arm and the armrest heater 1 varies depending on the weight of the arm due to the presence of the cushion layer 3 between the arm and the armrest heater 1. More specifically, when the occupant places the arm on the armrest A, a load is more likely to be applied to the elbow portion between the wrist and the elbow, and the distance to the armrest heater 1 becomes short. At this time, as illustrated in FIG. 12, in the armrest heater 1, by the configuration of being arranged so that the wiring interval H1 of the main wire portion 211 in the first region S1 is larger than the wiring interval H2 of the main wire portion 211 in the second region S2, that is, by providing a difference in the amount of heat generated in the X-axis direction by causing the wiring in the second region S2 where the wrist is likely to be placed to be dense and the wiring in the first region S1 where the elbow is likely to be placed to be sparse, it is possible to reduce the temperature difference felt by the occupant on the elbow and the wrist.

### Configuration and Operational Effects of Embodiment

Hereinafter, the configuration of the embodiment of the present disclosure and the operational effects thereof are described.

The armrest heater 1 according to the embodiment includes the sheet-like base material 100 that is arranged in the armrest A and the heater wire 200 that is wired along the main surface of the base material 100, the armrest heater 1 includes the first region S1 on one end of the armrest heater 1 in the first direction and the second region S2 on the other end of the armrest heater 1 in the first direction, and the heater wire 200 includes the heater forming wire portion 210 that forms the heater pattern in which the width of the heater forming wire portion 210 in the first region S1 in a second direction intersecting with the first direction of the armrest A is larger than the width of the heater forming wire portion 210 in the second region S2 in the second direction of the armrest A.

According to the above configuration, the heater wire 200 is arranged so that the width of the heater forming wire portion 210 in the first region S1 in the second direction of the armrest A is larger than the width of the heater forming wire portion 210 in the second region S2 in the second direction of the armrest A. That is, the wiring is performed so that the wiring area is large in a portion in which the elbow side portion of the arm having a large contact area is likely to be placed, and the wiring area is small in a portion in which the wrist having a small contact area is likely to be placed. Therefore, it is possible to suppress extra use of the heater wire 200 and to reduce the cost. In addition, since it is possible to save energy used for warming an unnecessary portion by suppressing the amount of heat generated in the wrist region, energy saving can be achieved.

In addition, in the armrest heater 1, when the armrest heater 1 is in a state of being used by an occupant seated on a seat, the second region S2 may be provided on the opposite side of the seat back B from the first region S1.

According to the above configuration, the heater wire 200 is arranged so that the width of the heater forming wire portion 210 in the first region S1 in the second direction of the armrest A is larger than the width of the heater forming wire portion 210 in the second region S2 in the second direction of the armrest A. That is, the wiring is performed so that the wiring area is large in a portion in which the elbow side portion of the arm having a large contact area is likely to be placed, and the wiring area is small in a portion in which the wrist having a small contact area is likely to be placed. Therefore, it is possible to suppress extra use of the heater wire 200 and to reduce the cost. In addition, since it is possible to save energy used for warming an unnecessary portion by suppressing the amount of heat generated in the wrist region, similarly, energy saving can be achieved.

Also, in the armrest heater 1, the heater forming wire portion 210 may be formed to have a heating region having a tapered shape from one end side toward the other end side.

According to the above configuration, since the heater wire 200 is arranged to follow the shape of the arm more, the arm of the occupant can be more efficiently warmed, and energy saving can be achieved.

Also, in the armrest heater 1, the heater forming wire portion 210 may include the main wire portion 211 extending in the second direction of the armrest A, and the length of the main wire portion 211 in the second region S2 may be shorter than the length of the main wire portion 211 in the first region S1.

According to the above configuration, the heater wire 200 is arranged so that the main wire portion 211 extending in the short direction of armrest A in the second region S2 is shorter in length than the main wire portion 211 extending in the short direction of the armrest A in the first region S1. That is, the wiring is performed so that the wiring area is large in a portion in which the elbow side portion of the arm having a large contact area is likely to be placed, and the wiring area is small in a portion in which the wrist having a small contact area is likely to be placed. Therefore, it is possible to suppress extra use of the heater wire 200 and to reduce the cost. In addition, since it is possible to save energy used for warming an unnecessary portion by suppressing the amount of heat generated in the wrist region, similarly, energy saving can be achieved.

Also, the armrest heater 1 may have a third region S3 arranged between the first region S1 and the second region S2, and the heater pattern formed in the heater forming wire portion 210 may be arranged such that the width in the second direction in the third region S3 is smaller than the width in the second direction in the first region S1 and larger than the width in the second direction in the second region S2.

According to the above configuration, the width of the heater wire 200 in the second direction of the armrest A stepwise decreases from the first region S1 to the second region S2 and from the second region S2 to the third region S3, so that the heater wire 200 has in a shape following the arm more, and thus the arm of the occupant can be efficiently warmed. Therefore, energy saving can be achieved.

Also, the armrest heater 1 further includes the fourth region S4 arranged on a side opposite to the first region S1 via the second region S2 in the first direction, and the heater wire 200 is arranged so that the wiring density of the fourth region S4 is higher than the wiring densities of the first region S1 and the second region S2.

According to the above configuration, while energy is saved by suppressing heating of unnecessary portions from the elbow to the wrist, the fourth region S4 that warms the palm that is easily cooled at the end of the human body has a high wiring density, so that a portion from the arm to the palm can be efficiently warmed to provide comfort to the occupant.

Also, in the armrest heater 1, the heater forming wire portion 210 in the second region S2 may be offset toward the center side of the seat back B.

According to the above configuration, since the heater forming wire portion 210 is offset toward the center side of the seat back B, that is, the heater wire 200 is close to the human body side, the heater wire 200 has a shape following the shape of the arm of the human body in which the side surface of the arm opposite to the human body side curves from the elbow to the wrist toward the center side of the human body when the arm is placed so that the back of the hand faces the ceiling side of the moving body. As a result, the arms of the occupant can be warmed more efficiently.

Further, in the armrest heater 1, the heater wire 200 further include the heater connection wire portion 220 electrically connected to the control unit 400 that controls heat generation of the heater wire 200, one end of the heater connection wire portion 220 is electrically connected to the control unit 400, the other end is electrically connected to the control unit 400 via the heater pattern formed in the heater forming wire portion 210, and in case of being in a state in which the armrest A is used by an occupant seated on the seat, the heater connection wire portion 220 may be arranged on a side opposite to the center side of the seat back B from the heater forming wire portion 210 in the second direction.

According to the above configuration, since the heater connection wire portion 220 is arranged on a side opposite to the center side of the seat back B from the heater forming wire portion 210, that is, the heater connection wire portion 220 is arranged close to the door side, it is possible to suppress the influence of cold radiation or the like on the door side. Therefore, discomfort feeling caused by the cooling of the door side of the armrest A due to the influence of cold radiation or the like when the occupant places the hand on the armrest A on the door side can be suppressed. Particularly, when the heater wire 200 is arranged so that the wiring area by the heater forming wire portion 210 in the human body region M2 is larger than the wiring area by the heater forming wire portion 210 in the door region M1, the heat generation amount on the door side is smaller than that of the occupant side, and also the door side is more likely to be cooled due to the influence of cold radiation. Therefore, the armrest A on the door side can be warmed by disposing the heater connection wire portion 220 in the door region M1.

Also, in the armrest heater 1, the heater wire 200 includes the main wire portion 211 extending in the second direction of the armrest A and is arranged so that the wiring interval H1 of the main wire portion 211 in the first region S1 is identical to the wiring interval H2 of the main wire portion 211 in the second region S2.

According to the above configuration, in the armrest heater 1, since the wiring interval H1 of the main wire portion 211 in the first region S1 is identical to the wiring interval H2 of the main wire portion 211 in the second region S2, the amount of heat generated in the heat generation region by the heater forming wire portion 210 in the X-axis direction is constant, and heat equalization can be achieved. Therefore, the occupant can obtain the same degree of thermal sense, for example, in the elbow portion and the wrist portion of the armrest A heated by the armrest heater 1.

Also, in the armrest heater 1, the heater wire 200 may include the main wire portion 211 extending in the second direction of the armrest A and may be arranged so that wiring interval H1 of the main wire portion 211 in the first region S1 is larger than the wiring interval H2 of the main wire portion 211 in the second region S2.

According to the above configuration, in the armrest heater 1, since the wiring interval H1 in the first region S1 is wide and the wiring interval H2 in the second region S2 is narrow, the amount of heat generated in the first region S1 in the X-axis direction is small, and the amount of heat generated in the second region S2 in the X-axis direction is large. In the human body, since the wrist is close to the end and is more easily cooled than the elbow, by increasing the amount of heat generation on the wrist and decreasing the amount of heat generation on the elbow, the arm of the occupant can be efficiently warmed in accordance with the ease of cooling. Therefore, heat generation in a portion in which the wrist is not positioned can be suppressed, and the wrist that is easily cooled can be warmed, so that the efficiency of the armrest heater 1 can be further improved.

Also, the armrest A may be provided with the skin layer 2 that covers a surface side of the armrest A to which a load is applied by the arm of the occupant, and the armrest heater 1 may be arranged on the back side of the skin layer 2.

According to the above configuration, since the armrest heater 1 is arranged on the back side of the skin layer 2, the skin layer 2 of the armrest A can be directly warmed, and thus quick warmth can be obtained. Particularly, when the armrest heater 1 is arranged immediately below the skin layer 2, further quick warmth can be obtained. In addition, since the armrest heater 1 is immediately below the skin layer 2, the distance between the armrest heater 1 and the arm does not change even if the weight of the arm of the occupant affects when the occupant places the arm.

Therefore, in the armrest heater 1, when the wiring interval H1 of the main wire portion 211 in the first region S1 is identical to the wiring interval H2 of the main wire portion 211 in the second region S2, the skin layer 2 of the armrest A can be uniformly warmed, so that the arms of the occupant can be warmed at a uniform temperature.

In the armrest A provided with the skin layer 2 that covers the surface side of the armrest A to which a load is applied by the arms of the occupant and the cushion layer 3 that is arranged on the back side of the skin layer 2, the armrest heater 1 is arranged so as to face the skin layer 2 via the cushion layer 3.

According to the above configuration, since the armrest heater 1 is arranged under the cushion layer 3, the heater wire 200 is less likely to be damaged even in long-term use. In addition, at this time, by providing the cushion layer 3, when the occupant places the arm, with respect to the wrist and the elbow, the distance from the elbow to the armrest heater 1 is shorter. At this time, in the armrest heater 1, by the configuration of being arranged so that the wiring interval H1 of the main wire portion 211 in the first region S1 is larger than the wiring interval H2 of the main wire portion 211 in the second region S2, that is, by providing a difference in the amount of heat generated in the X-axis direction by causing the wiring in the second region S2 to be dense and the wiring in the first region to be sparse, it is possible to reduce the temperature difference felt by the arm of the occupant on the elbow and the wrist.

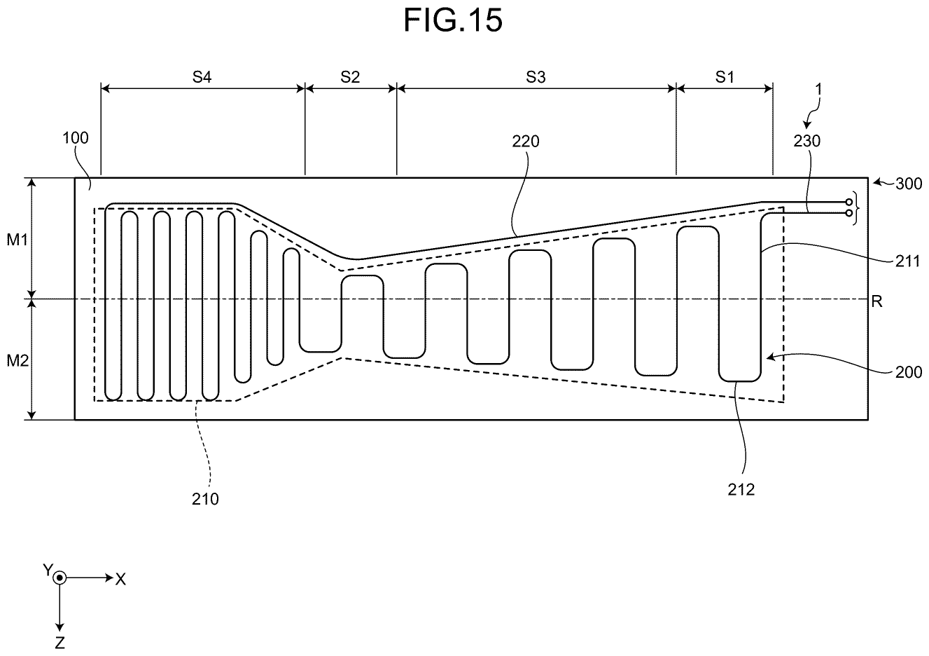

In the above, some embodiments of the present disclosure are described, but these embodiments are presented as examples and are not intended to limit the scope of the invention. These embodiments can be implemented in various other forms, and various omissions, substitutions, and changes can be made without departing from the gist of the invention. For example, the first modification may be combined with the second modification. FIG. 15 is a schematic view illustrating an armrest heater obtained by combining the second modification with the first modification of the embodiment of the present disclosure. As illustrated in FIG. 15, the armrest heater 1 includes the fourth region S4 on the opposite side (on the left side in FIG. 15, the negative direction of the X axis) of the seat back B from the second region S2 and is arranged such that the wiring area of the heater forming wire portion 210 in the human body region M2 is larger than the wiring area of the heater forming wire portion 210 in the door region M1. As a result, since the heater wire 200 is close to the human body side, it is possible to more accurately correspond to the shape of the arm of the occupant, and thus the arm of the occupant can be warmed more efficiently. Further, by setting the wiring density of the fourth region S4 to be higher than the wiring density of the first region S1, the wiring density of the second region S2, and the wiring density of the third region S3, it is possible to make the palm that is easily cooled have the same thermal sense as other parts of the arm. Further, the heater pattern is formed into a trapezoidal shape from the first region S1 to the second region S2 as illustrated in FIG. 15 while having the fourth region S4, it is possible to save energy while efficiently warming the arm. These embodiments and modifications thereof are included in the scope and gist of the invention, and included in the invention described in the claims and the equivalent scope thereof in the same manner.

An example of the present disclosure provides an armrest heater capable of saving energy. Further advantages and effects in one example of the present disclosure are apparent from the specification and drawings. Note that advantages and/or effects according to one example of the present disclosure are provided by several embodiments and features described in the specification and drawings, respectively, but not all of them are necessarily provided in order to obtain one or more identical features.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplement

The following technique is disclosed by the above description of the embodiments.

(1) An armrest heater provided on an armrest of a seat having a seat back, includes:
a sheet-like base material that is arranged in the armrest; and
a heater wire that is wired along a main surface of the base material,
the armrest heater including a first region on one end side in a first direction of the armrest and a second region on another end side in the first direction of the armrest, and
the heater wire including a heater forming wire portion, the heater forming wire portion having a heater pattern in which a width of the first region in a second direction intersecting with the first direction is larger than a width of the second region in the second direction.
   (2) In the armrest heater according to (1), when the armrest is being used by an occupant seated on the seat, the second region of the armrest heater is provided on a side opposite to the seat back from the first region in the first direction.
   (3) In the armrest heater according to (1) or (2), the heater forming wire portion forms a heating region having a tapered shape from the one end side toward the other end side in the first direction.
   (4) In the armrest heater according to any one of (1) to (3),
the heater pattern formed in the heater forming wire portion includes a main wire portion extending in the second direction of the armrest, and
a length of the main wire portion in the second region is shorter than a length of the main wire portion in the first region.
   (5) In the armrest heater according to any one of (1) to (4),
the armrest heater further includes a third region arranged between the first region and the second region in the first direction, and
in the heater pattern formed in the heater forming wire portion, a width of the third region in the second direction is less than a width of the first region in the second direction and more than a width of the second region in the second direction.
   (6) In the armrest heater according to any one of (1) to (5),
the armrest heater further includes a third region arranged between the first region and the second region in the first direction, and
in the heater pattern formed in the heater forming wire portion, a length of the main wire portion in the third region is less than a length of the main wire portion in the first region and longer than a length of the main wire portion in the second region.
   (7) In the armrest heater according to any one of (1) to (6),
the armrest heater further includes a fourth region that is arranged on a side opposite to the first region via the second region in the first direction, and
in the heater pattern formed in the heater forming wire portion, a wiring density in the fourth region is higher than a wiring density in the first region or the second region.
   (8) In the armrest heater according to any one of (1) to (7), the heater forming wire portion in the second region is offset toward a center side of the seat back.
   (9) In the armrest heater according to any one of (1) to (8),
the heater wire further includes a heater connection wire portion that is electrically connected to a control unit that controls generation of heat of the heater wire,
one end of the heater connection wire portion is electrically connected to the control unit, and another end thereof is electrically connected to the control unit via the heater pattern formed in the heater forming wire portion, and
when the armrest is being used by an occupant seated on the seat, the heater connection wire portion is arranged on a side opposite to a center side of the seat back from the heater forming wire portion in the second direction.
   (10) In the armrest heater according to any one of (1) to (9),
the heater pattern formed in the heater forming wire portion includes a main wire portion extending in the second direction of the armrest, and
a wiring interval of the main wire portion in the first region is identical to a wiring interval of the main wire portion in the second region.
   (11) In the armrest heater according to any one of (1) to (9),
the heater pattern formed in the heater forming wire portion includes a main wire portion extending in the second direction of the armrest, and
a wiring interval of the main wire portion in the first region is larger than a wiring interval of the main wire portion in the second region.
   (12) In the armrest heater according to any one of (1) to (11), in the armrest provided with a skin layer that covers a surface side of the armrest to which a load is applied by an arm of an occupant, the armrest heater is arranged on a back side of the skin layer.
   (13) In the armrest heater according to any one of (1) to (11),
in the armrest provided with a skin layer that covers a surface side of the armrest to which a load is applied by an arm of an occupant, and a cushion layer that is arranged on a back side of the skin layer,
the armrest heater is arranged to face the skin layer via the cushion layer.

What is claimed is:

1. An armrest heater provided on an armrest of a seat having a seat back, the armrest heater comprising:
a sheet-like base material that is arranged in the armrest; and
a heater wire that is wired along a main surface of the base material,
the armrest heater including a first region on one end side in a first direction of the armrest and a second region on another end side in the first direction of the armrest, and
the heater wire including a heater forming wire portion, the heater forming wire portion having a heater pattern in which a width of the first region in a second direction intersecting with the first direction is larger than a width of the second region in the second direction.

2. The armrest heater according to claim 1, wherein
when the armrest is being used by an occupant seated on the seat, the second region of the armrest heater is provided on a side opposite to the seat back from the first region in the first direction.

3. The armrest heater according to claim 1, wherein
the heater forming wire portion forms a heating region having a tapered shape from the one end side toward the other end side in the first direction.

4. The armrest heater according to claim 2, wherein
the heater forming wire portion forms a heating region having a tapered shape from the one end side toward the other end side in the first direction.

5. The armrest heater according to claim 1, wherein
the heater pattern formed in the heater forming wire portion includes a main wire portion extending in the second direction of the armrest, and
a length of the main wire portion in the second region is shorter than a length of the main wire portion in the first region.

6. The armrest heater according to claim 2, wherein
the heater pattern formed in the heater forming wire portion includes a main wire portion extending in the second direction of the armrest, and
a length of the main wire portion in the second region is shorter than a length of the main wire portion in the first region.

7. The armrest heater according to claim 3, wherein
the heater pattern formed in the heater forming wire portion includes a main wire portion extending in the second direction of the armrest, and
a length of the main wire portion in the second region is shorter than a length of the main wire portion in the first region.

8. The armrest heater according to claim 4, wherein
the heater pattern formed in the heater forming wire portion includes a main wire portion extending in the second direction of the armrest, and
a length of the main wire portion in the second region is shorter than a length of the main wire portion in the first region.

9. The armrest heater according to claim 1, wherein
the armrest heater further includes a third region arranged between the first region and the second region in the first direction, and
in the heater pattern formed in the heater forming wire portion, a width of the third region in the second direction is less than a width of the first region in the second direction and more than a width of the second region in the second direction.

10. The armrest heater according to claim 5, wherein
the armrest heater further includes a third region arranged between the first region and the second region in the first direction, and
in the heater pattern formed in the heater forming wire portion, a length of the main wire portion in the third region is less than a length of the main wire portion in the first region and longer than a length of the main wire portion in the second region.

11. The armrest heater according to claim 1, wherein
the armrest heater further includes a fourth region that is arranged on a side opposite to the first region via the second region in the first direction, and
in the heater pattern formed in the heater forming wire portion, a wiring density in the fourth region is higher than a wiring density in the first region or the second region.

12. The armrest heater according to claim 1, wherein
the heater forming wire portion in the second region is offset toward a center side of the seat back.

13. The armrest heater according to claim 1, wherein
the heater wire further includes a heater connection wire portion that is electrically connected to a control unit that controls generation of heat of the heater wire,
one end of the heater connection wire portion is electrically connected to the control unit, and another end thereof is electrically connected to the control unit via the heater pattern formed in the heater forming wire portion, and
when the armrest is being used by an occupant seated on the seat, the heater connection wire portion is arranged on a side opposite to a center side of the seat back from the heater forming wire portion in the second direction.

14. The armrest heater according to claim 12, wherein
the heater wire further includes a heater connection wire portion that is electrically connected to a control unit that controls generation of heat of the heater wire,
one end of the heater connection wire portion is electrically connected to the control unit, and another end thereof is electrically connected to the control unit via the heater pattern formed in the heater forming wire portion, and
when the armrest is being used by an occupant seated on the seat, the heater connection wire portion is arranged on a side opposite to a center side of the seat back from the heater forming wire portion in the second direction.

15. The armrest heater according to claim 1, wherein
the heater pattern formed in the heater forming wire portion includes a main wire portion extending in the second direction of the armrest, and
a wiring interval of the main wire portion in the first region is identical to a wiring interval of the main wire portion in the second region.

16. The armrest heater according to claim 1, wherein
the heater pattern formed in the heater forming wire portion includes a main wire portion extending in the second direction of the armrest, and
a wiring interval of the main wire portion in the first region is larger than a wiring interval of the main wire portion in the second region.

17. The armrest heater according to claim 1, wherein
in the armrest provided with a skin layer that covers a surface side of the armrest to which a load is applied by an arm of an occupant, the armrest heater is arranged on a back side of the skin layer.

18. The armrest heater according to claim 15, wherein
in the armrest provided with a skin layer that covers a surface side of the armrest to which a load is applied by an arm of an occupant, the armrest heater is arranged on a back side of the skin layer.

19. The armrest heater according to claim 1, wherein
in the armrest provided with a skin layer that covers a surface side of the armrest to which a load is applied by an arm of an occupant, and a cushion layer that is arranged on a back side of the skin layer,
the armrest heater is arranged to face the skin layer via the cushion layer.

20. The armrest heater according to claim 16, wherein
in the armrest provided with a skin layer that covers a surface side of the armrest to which a load is applied by an arm of an occupant, and a cushion layer that is arranged on a back side of the skin layer,
the armrest heater is arranged to face the skin layer via the cushion layer.
